(19) United States
(12) Patent Application Publication
(10) Pub. No.: US 2025/0142425 A1
(43) Pub. Date: May 1, 2025

(54) METHOD, DEVICE AND COMPUTER STORAGE MEDIUM OF COMMUNICATION

(71) Applicant: NEC CORPORATION, Tokyo (JP)

(72) Inventors: Da WANG, Beijing (CN); Lin LIANG, Beijing (CN); Gang WANG, Beijing (CN)

(73) Assignee: NEC CORPORATION, Tokyo (JP)

(21) Appl. No.: 18/838,950

(22) PCT Filed: Feb. 17, 2022
(86) PCT No.: PCT/CN2022/076675

§ 371 Date: Aug. 15, 2024

(51) Int. Cl. H04W 36/00; H04W 12/041; H04W 36/36; H04W 76/20

(52) U.S. Cl. CPC H04W 36/0069; H04W 12/041; H04W 36/362; H04W 76/20

(57) ABSTRACT

Embodiments of the present disclosure relate to methods, devices and computer readable media for communication. A terminal device receives, from a first network device, a conditional reconfiguration indicating that a subsequent conditional cell change is enabled. If the subsequent conditional cell change to a candidate cell is to be performed after a cell change or addition is performed, the terminal device determines a first counter value, the first counter value being different from a second counter value used for the cell change or addition, and determines, based on the first counter value, a security key for communication with a second network device providing the candidate cell. In this way, a security key is determined for a subsequent conditional cell change.

### TECHNICAL FIELD

Embodiments of the present disclosure generally relate to the field of telecommunication, and in particular, to methods, devices and computer storage media of communication for a subsequent conditional cell change.

### BACKGROUND

Currently, multi-random access technology dual connectivity (MR-DC) with selective activation of cell groups aims at enabling a subsequent conditional primary secondary cell (PSCell) change (CPC) after secondary cell group (SCG) change, without reconfiguration and re-initialization on a CPC/conditional PSCell addition (CPA) preparation from the network side. This results in a reduction of signaling overhead and an interrupting time for SCG change.

In case of a subsequent CPC being enabled, a terminal device may perform CPC multiple times using the same radio resource control (RRC) reconfiguration. However, in a CPC/CPA procedure of third generation partnership project (3GPP) Release 17, a RRC reconfiguration is applied only once, and thus a secondary node (SN) counter configured in the RRC reconfiguration is used only once to generate a security key for the CPC/CPA procedure. Thus, how to determine a security key for a subsequent CPC after the CPC/CPA procedure needs to be addressed.

### SUMMARY

In general, embodiments of the present disclosure provide methods, devices and computer storage media of communication for a subsequent conditional cell change.

In a first aspect, there is provided a method of communication. The method comprises: receiving, at a terminal device and from a first network device, a conditional reconfiguration for a set of candidate cells, the conditional reconfiguration indicating that a subsequent conditional cell change is enabled; in accordance with a determination that the subsequent conditional cell change to a candidate cell in the set of candidate cells is to be performed after a cell change or addition is performed, determining a first counter value, the first counter value being different from a second counter value used for the cell change or addition; and determining, based on the first counter value, a security key for communication with a second network device providing the candidate cell.

In a second aspect, there is provided a method of communication. The method comprises: determining, at a first network device, a set of security keys based on a set of first counter values, the set of first counter values being used for a subsequent conditional cell change to a candidate cell in the set of candidate cells to be performed after a cell change or addition is performed and being different from a second counter value used for the cell change or addition; and transmitting the set of security keys to a second network device providing the candidate cell for communication between a terminal device and the second network device.

In a third aspect, there is provided a method of communication. The method comprises: receiving, at a second network device, a set of security keys from a first network device; and performing, based on a security key in the set of security keys, a communication between a terminal device and the second network device providing a candidate cell, a subsequent conditional cell change to the candidate cell being to be performed after a cell change or addition is performed, the security key being different from a previous security key used for the cell change or addition.

In a fourth aspect, there is provided a method of communication. The method comprises: receiving, at a terminal device and from a first network device, a conditional reconfiguration for a set of candidate cells, the conditional reconfiguration indicating that a subsequent conditional cell change is enabled; and in accordance with a determination that the subsequent conditional cell change to a candidate cell in the set of candidate cells is to be performed after a cell change or addition is performed, applying the conditional reconfiguration for a second network device providing the candidate cell, wherein a security key used for the cell change or addition is the same as a security key used for the subsequent conditional cell change.

In a fifth aspect, there is provided a method of communication. The method comprises: transmitting, at a first network device and to a terminal device, a conditional reconfiguration for a set of candidate cells so that a security key used for a cell change or addition is the same as a security key used for a subsequent conditional cell change to be performed after the cell change or addition is performed.

In a sixth aspect, there is provided a terminal device. The terminal device comprises a processor configured to cause the terminal device to perform the method according to the first or fourth aspect of the present disclosure.

In a seventh aspect, there is provided a network device. The network device comprises a processor configured to cause the network device to perform the method according to any of the second, third and fifth aspects of the present disclosure.

In an eighth aspect, there is provided a computer readable medium having instructions stored thereon. The instructions, when executed on at least one processor, cause the at least one processor to perform the method according to the first or fourth aspect of the present disclosure.

In a ninth aspect, there is provided a computer readable medium having instructions stored thereon. The instructions, when executed on at least one processor, cause the at least one processor to perform the method according to any of the second, third and fifth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram illustrating network protocol layer entities that may be established for a user plane (UP) protocol stack at devices according to some embodiments of the present disclosure;

FIG. 1C illustrates a schematic diagram illustrating network protocol layer entities that may be established for a control plane (CP) protocol stack at devices according to some embodiments of the present disclosure;

FIG. 2 illustrates a schematic diagram illustrating an example process of determining a security key for a subsequent CPC according to embodiments of the present disclosure;

FIG. 3 illustrates a schematic diagram illustrating another example process of determining a security key for a subsequent CPC according to embodiments of the present disclosure;

FIG. 4 illustrates an example method of communication implemented at a terminal device in accordance with some embodiments of the present disclosure;

FIG. 5 illustrates an example method of communication implemented at a first network device in accordance with some embodiments of the present disclosure;

FIG. 6 illustrates an example method of communication implemented at a second network device in accordance with some embodiments of the present disclosure;

FIG. 7 illustrates another example method of communication implemented at a terminal device in accordance with some embodiments of the present disclosure;

FIG. 8 illustrates another example method of communication implemented at a first network device in accordance with some embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “a cell change or addition” may be interchangeably used with “reconfigurationWithSync for SCG or master cell group (MCG)”. In the context of the present application, the term “PSCell” refers to a SpCell of a SCG, the term “PCell” refers to a SpCell of a MCG, and the term “SpCell” refers to a primary cell of a SCG or MCG.

As mentioned above, how to determine a security key for a subsequent CPC after a CPC/CPA procedure needs to be addressed. In view of this, embodiments of the present disclosure provide solutions of determining a security key for a subsequent conditional cell change after a cell change or addition. In one aspect, if a subsequent conditional cell change is to be performed after a cell change or addition is performed, a counter value different from that used for the cell change or addition is determined. Based on the determined counter value, a security key is determined for the subsequent conditional cell change. In this way, a change of a security key is supported for a subsequent conditional cell change.

In another aspect, if a subsequent conditional cell change is to be performed after a cell change or addition is performed, a counter value same as that used for the cell change or addition is determined. Based on the determined counter value, a security key is determined for the subsequent conditional cell change. In this way, no change of a security key is required for a subsequent conditional cell change.

It is to be understood that the present solutions may be applied in a SCG change, and also may be applied in a MCG change. That is, the present solutions may be applied for a subsequent CPC or a subsequent conditional handover. The subsequent CPC or subsequent conditional handover may also be referred to as a selective activation of cell groups, a selective activation of SCGs, a subsequent SCG change, a subsequent cell group change or a subsequent conditional cell change. For convenience, embodiments of the present disclosure will be described by taking a subsequent CPC as an example.

Principles and implementations of the present disclosure will be described in detail below with reference to the figures.

### Example of Communication Network

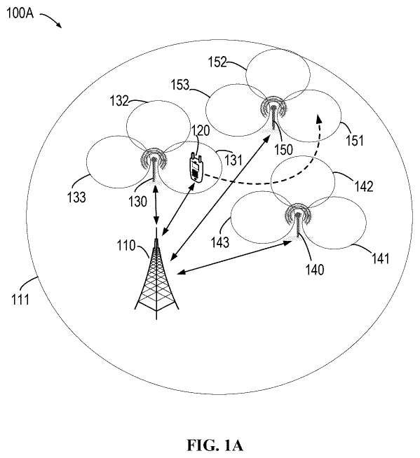

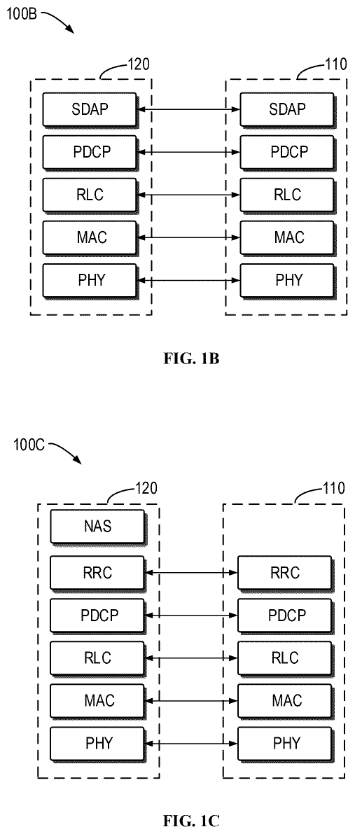

FIG. 1A illustrates a schematic diagram of an example communication network 100A in which embodiments of the present disclosure can be implemented. As shown in FIG. 1A, the communication network 100A may comprise a network device 110 and a terminal device 120. The network device 110 provides a cell 111 and the terminal device 120 is located in the cell 111 and served by the network device 110.

The communication network 100A may also comprise one or more other network devices such as network devices 130, 140 and 150. The network device 130 provides cells 131, 132 and 133. The network device 140 provides cells 141, 142 and 143, and the network device 150 provides cells 151, 152 and 153. It should be noted that the number of the cells are not limited to three, and more or less cells are also configured for the terminal device 110.

Assuming that the terminal device 120 may establish a dual connection (i.e., simultaneous connection) with two network devices. For example, the network device 110 may serve as a MN (for convenience, also referred to as MN 110 below), and the network device 130 may serve as a SN (for convenience, also referred to as SN 130 below). Although only the cell 111 is shown, the MN 110 may provide multiple cells, and these cells may form a MCG for the terminal device 120. Assuming that the cell 111 is a primary cell (i.e., PCell) in the MCG. Further, the cells 131, 132 and 133 provided by the network device 130 may form a SCG for the terminal device 120. Assuming that the cell 131 is a primary cell (i.e., PSCell) in the SCG.

The SN 130 may communicate with the terminal device 120 via a channel such as a wireless communication channel. Similarly, the MN 110 may also communicate with the terminal device 120 via a channel such as a wireless communication channel. The SN 130 may communicate with the MN 110 via a control-plane interface such as Xn-C. The MN 110 may communicate with the core network 160 such as the AMF 162 via a control-plane interface such as NG-C. The SN 130 may also communicate with the MN 110 via a user plane interface such as Xn-U, and communicate with the core network 160 such as the UPF 161 via a user plane interface such as NG-U.

It is to be understood that the number of devices or cells in FIG. 1A is given for the purpose of illustration without suggesting any limitations to the present disclosure. The communication network 100A may involve any suitable number of network devices and/or terminal devices and/or cells adapted for implementing implementations of the present disclosure.

The communications in the communication network 100A may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Communication in a direction from the terminal device 120 towards the network device 110, 130, 140 or 150 is referred to as UL communication, while communication in a reverse direction from the network device 110, 130, 140 or 150 towards the terminal device 120 is referred to as DL communication. The terminal device 120 can move amongst the cells of the network devices 110, 130, 140 or 150 and possibly other network devices. In UL communication, the terminal device 120 may transmit UL data and control information to the network device 110, 130, 140 or 150 via a UL channel. In DL communication, the network device 110, 130, 140 or 150 may transmit DL data and control information to the terminal device 120 via a DL channel.

The communications in the communication network 100A can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure. For convenience, the following description is given by taking a communication between the terminal device 120 and the network device 110 as an example. It is to be understood that the following description is also suitable for the communication between the terminal device 120 and the network device 130, 140 or 150.

As shown in FIG. 1B, in the UP, each of the terminal device 120 and the network device 110 may comprise an entity for the L1 layer, i.e., an entity for a physical (PHY) layer (also referred to as a PHY entity), and one or more entities for upper layers (L2 and layer 3 (L3) layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 120 and the network device 110 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 120 may also comprise an entity for a non-access stratum (NAS) layer (also referred to as a NAS entity). An NAS layer at the network side is not located in a network device and is located in a core network (CN, not shown). In some cases, these entities are in a stack structure.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and an random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 120 may be configured with at least one data radio bearer (DRB) for bearing data plane data and at least one signaling radio bearer (SRB) for bearing control plane data.

In some embodiments, the network device 110 may configure, to the terminal device 120, a conditional reconfiguration (also referred to as a RRC reconfiguration) for a set of candidate cells. The conditional reconfiguration may indicate that a subsequent CPC is enabled.

Assuming that the cells 131-133, 141-143 and 151-153 are configured to the terminal device 110 as candidate cells. In some scenarios, the terminal device 120 may initially communicate with only the network device 110. As the terminal device 120 moves, when a condition for a candidate cell (for example, the cell 131) is fulfilled, the terminal device 120 may be caused to establish the dual connection with the network device 110 and the network device 130. This process of SN addition may be called as a CPA.

In some scenarios, the terminal device 120 may establish a dual connection with the network devices 110 and 130. The network device 110 serves as a MN and the network device 130 serves as a SN. As the terminal device 120 moves, when a condition for another candidate cell (for example, the cell 142) is fulfilled, a SN serving the terminal device 120 may be changed from the network device 130 (also referred to as a source SN or current SN 130) to the network device 140 (also referred to as a target SN 140). This process of PScell change may be called as a CPC. In some scenarios, after the terminal device is configured with conditional reconfiguration and with subsequent CPC being enabled, and before at least one execution condition is fulfilled for any candidate PScell, the terminal device 120 may receive a RRC Reconfiguration message containing reconfiguration WithSync for SCG from the network device 110, and the terminal device 120 may perform a PScell change or addition accordingly. This procedure is called as legacy PScell change or addition. As an example, after the legacy PSCell change or addition procedure, the SN serving the terminal device 120 is the network device 140.

After the above CPA, CPC or legacy PSCell change/addition procedure, as the terminal device 120 further moves, when a condition for still another candidate cell (for example, the cell 152) is fulfilled, a SN serving the terminal device 120 may be changed from the network device 140 to the network device 150 (also referred to as a target SN 150). This process of SN change may be called as a subsequent CPC. As the terminal device 120 further moves, several more rounds of subsequent CPC can be performed.

In a conventional solution, when a MN establishes a security context between a SN and a terminal device for the first time for a given AS security context shared between the MN and the terminal device, the MN generates a security key KsN for the SN and transmits the security key KsN to the SN over an Xn-C interface. To generate the security key KSN, the MN associates a counter with a current AS security context. The counter is called as a SN counter or sk-counter. The SN counter is used as freshness input into KsN derivations as described in the clause 6.10.3.2 of 3GPP specification TS 33.501. The MN transmits a value of the SN counter to the terminal device over a RRC signaling path. The terminal device may use the value of the SN counter to generate the security key KsN. The security key KsN is used to derive further RRC and UP keys that are used in communication between the terminal device and the SN.

In legacy cell change or addition procedure or in CPC/CPA procedure, a RRC reconfiguration with reconfiguration WithSync for SN is applied only once, and thus the SN counter configured is used only once. However, in case of a subsequent CPC being enabled, a terminal device may perform CPC multiple times using the same RRC reconfiguration. In this case, a security key for the subsequent CPC is indefinite.

Embodiments of the present disclosure provide solutions for determining a security key for a subsequent conditional cell change such as subsequent CPC.

### Example Implementation of Change of Security Key for Subsequent CPC

In the present solution, a conditional reconfiguration comprises information indicating that a subsequent conditional cell change is enabled for at least one candidate cell in a set of candidate cells. If a cell change or addition is performed, at least a portion of the conditional reconfiguration is maintained for the at least one candidate cell. In this way, an enabling of a subsequent conditional cell change can be achieved in a flexible way. For convenience, more detailed description will be given below by taking a subsequent CPC as an example.

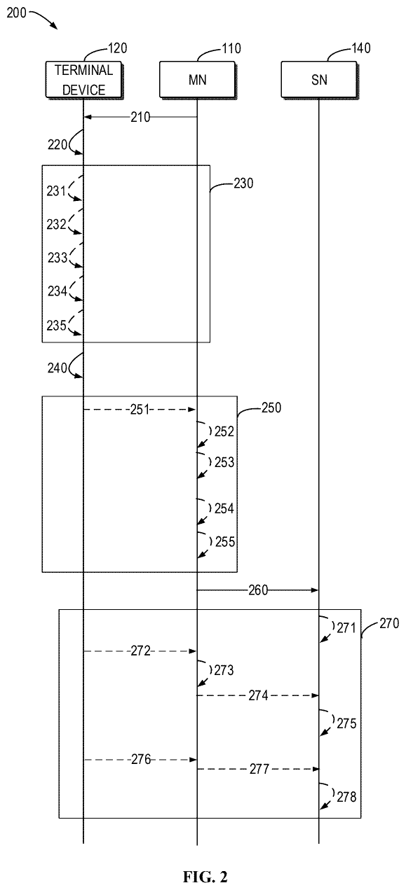

FIG. 2 illustrates a schematic diagram illustrating an example process 200 of determining a security key for a subsequent CPC according to embodiments of the present disclosure. For the purpose of discussion, the process 200 will be described with reference to FIG. 1A. The process 200 may involve the terminal device 120 and the network devices 110 and 140 as illustrated in FIG. 1A. In this example, the network device 110 is a MN (for convenience, called as MN 110 hereinafter) serving the terminal device 120, the network device 140 is a potential target SN (for convenience, called as SN 140 hereinafter) serving the terminal device 120. Assuming that the network device 130 is a source SN serving the terminal device 120 and the terminal device 120 is in the cell 131 (i.e., a source cell or current cell).

As shown in FIG. 2, the MN 110 transmits 210, to the terminal device 120, a conditional reconfiguration for a set of candidate cells. The set of candidate cells refers to one or more candidate cells. The conditional reconfiguration indicates that a subsequent CPC is enabled.

The terminal device 120 determines 220 whether a CPC (i.e., a subsequent CPC) is to be performed after a cell change or addition is performed. The subsequent CPC is to be performed from the current cell to a candidate cell (for example, the cell 142 provided by the SN 140) in the set of candidate cells.

If the subsequent CPC is to be performed, the terminal device 120 determines 230 a counter value (for convenience, also referred to as a first counter value) different from a counter value (for convenience, also referred to a second counter value) used for the cell change or addition previously performed. The previous performed cell change or addition can be legacy cell change or addition, or conditional cell change/addition. The previous performed cell change or addition can be first cell change/addition, or subsequent cell change. One or multiple cell change/addition can be performed before the subsequent CPC. Some example embodiments for the determination of the first counter value will be described in connection with Embodiments 1 to 2.

### Embodiment 1

In this embodiment, the conditional reconfiguration may comprise a counter value configured for the terminal device 120. The terminal device 120 may increase the counter value autonomously to derive a security key of a SN.

With reference to FIG. 2, in some embodiments, the terminal device 120 may store 231 the counter value configured for the terminal device 120. In some embodiments, the terminal device 120 may store the counter value in a variable of the terminal device 120. In some embodiments, the terminal device 120 may store the counter value in an AS security context of the terminal device 120. Of course, the counter value may be stored in any other suitable ways.

In some embodiments, the terminal device 120 may store the counter value upon performing of the cell change or addition. In other words, the terminal device 120 may store the counter value upon performing a cell change or addition for the first time after the reception of conditional reconfiguration. In some embodiments, the terminal device 120 may store the counter value upon reception of the counter value in the conditional reconfiguration. In this way, an initial value of the counter value may be stored.

In some embodiments, the terminal device 120 may determine 232 the first counter value by increasing the stored counter value. In other words, for each subsequent CPC procedure, the terminal device 120 may increase the stored counter value, and derive a security key for the subsequent CPC procedure based on the increased counter value. For example, the terminal device 120 may increase the stored counter value by one or in any other suitable ways. In this way, different counter values may be maintained for each subsequent CPC procedure.

### Embodiment 2

In this embodiment, the conditional reconfiguration may comprise at least one set of counter values configured for the terminal device 120. A set of counter values in the at least one set of counter values is used for a candidate cell. The terminal device 120 may select one counter value from the set of counter values that is unused before the subsequent CPC.

In some embodiments, the at least one set of counter values only comprises a set of counter values. For example, the set of counter values is used for each candidate cell in the set of candidate cells. That is, a set of counter values may be configured per UE. In this case, the set of counter values is the same for all the candidate cells.

In some embodiments, the at least one set of counter values comprises a first set of counter values and a second set of counter values, the first set of counter values being used for a first candidate cell in the set of candidate cells, the second set of counter values being used for a second candidate cell in the set of candidate cells. In other words, a set of counter values is separately configured for each candidate cell. That is, a set of counter values may be configured per candidate cell. In this case, a set of counter values may be the same or different between candidate cells.

In some embodiments, the terminal device 120 may determine a set of counter values in the at least one set of counter values that is used for the candidate cell to which the subsequent CPC is to be performed. With reference to FIG. 2, the terminal device 120 may determine 233, as the first counter value, a counter value in the set of counter values that is unused before the subsequent CPC. If there are multiple counter values that are unused, the terminal device 120 may select one from the multiple counter values in a predetermined order or randomly. In some alternative embodiments, the terminal device 120 deletes a counter value after using the counter value.

In some embodiments, the terminal device 120 may determine 234 whether no counter value in the set of counter values to be used, that is, whether all the counter values have been used or no counter value available. If no counter value to be used, the terminal device 120 may discard 235 a conditional reconfiguration entry and a measurement configuration for at least one candidate cell.

For example, in some embodiments where a set of counter values is configured per UE, if there is no more spare counter value to use, the terminal device 120 may discard conditional reconfiguration entries and measurement configurations for all the candidate cells. In another example, in some embodiments where a set of counter values is configured per candidate cell, if there is no more spare counter value for one candidate cell, the terminal device 120 may discard the corresponding conditional reconfiguration entry and measurement configuration for the one candidate cell.

In this way, different counter values may be determined for each subsequent CPC procedure.

Still with reference to FIG. 2, upon determination of the first counter value, the terminal device 120 determines 240 a security key based on the first counter value. The security key may be used for communication between the terminal device 120 and the SN 140. For example, the first counter value may be used as freshness input into KSN derivations as described in clause 6.10.3.2 of 3GPP TS33.501. In this way, a security key (KSN) may be derived. It is to be understood that the determination of the security key based on the first counter value may be performed in any other suitable ways, and the present disclosure does not limit this aspect.

So far, it is described that the terminal device 120 determines the security key for communication with the SN 140. Correspondingly, the SN 140 may also determine the security key for communication with the terminal device. The SN 140 may determine the security key based on security key information received from the MN 110.

As shown in FIG. 2, the MN 110 determines 250 a set of security keys based on a set of first counter values and transmits 260 the set of security keys to the SN 140. The SN 140 determines 270 a security key in the set of security keys for communication with the terminal device 120 in the subsequent CPC, the security key used for the subsequent CPC being different from a security key used for the previous cell change or addition. Some example embodiments on determination of the security key at the SN 140 will be described in connection with Embodiments 3 to 4.

### Embodiment 3

In this embodiment, the MN 110 determines a security key based on a first counter value and transmits the security key to the SN 140. In this way, a security key for a subsequent CPC is caused to be different from that for a previous cell change or addition.

With reference to FIG. 2, after triggering of the subsequent CPC, the terminal device 120 may transmit 251 a RRC reconfiguration complete message to the MN 110. The RRC reconfiguration complete message may comprise a conditional reconfiguration identity (ID).

Upon reception of the RRC reconfiguration complete message, the MN 110 may determine 252 the first counter value. In some embodiments where the conditional reconfiguration comprising one counter value configured for the terminal device 120, the MN 110 may determine the first counter value by increasing the counter value configured for the terminal device 120. For example, the counter value may be increased by one for each subsequent CPC procedure or in any other suitable ways.

In some embodiments where the conditional reconfiguration comprising at least one set of counter values configured for the terminal device 120, the MN 110 may determine a set of counter values in at least one set of counter values that is used for the candidate cell, and determine, as the first counter value, a counter value in the set of counter values. For example, the MN 110 may select one from the set of counter values in a predetermined order. For another example, the MN 110 may select the one unused counter value in the set of counter values.

In some embodiments, the at least one set of counter values only comprises a set of counter values, the set of counter values being used for each candidate cell in the set of candidate cells. In some embodiments, the at least one set of counter values comprises a first set of counter values and a second set of counter values, the first set of counter values being used for a first candidate cell in the set of candidate cells, the second set of counter values being used for a second candidate cell in the set of candidate cells. In some embodiments, the first set of counter values may be the same as the second set of counter values. In some embodiments, the first set of counter values may be different from the second set of counter values.

In some embodiments, the MN 110 may receive information of the first counter value from the terminal device 120. For example, the information of the first counter value may be comprised in the RRC reconfiguration complete message to the MN 110. It is to be understood that the information of the first counter value may be carried in any other suitable forms. In some embodiments, the information of the first counter value may comprise at least one of the following: the first counter value used by the terminal device 120, a difference between the first counter value and a counter value configured for the terminal device 120, or a count for the subsequent CPC. A count for the subsequent CPC can be the number of times of subsequent CPC procedures that have been performed. It is to be understood that any other suitable information is also feasible. Based on the information of the first counter value, the MN 110 may determine the first counter value.

Upon determination of the first counter value, the MN 110 may determine 253 the security key of the SN 140 based on the first counter value. For example, the first counter value may be used as freshness input into KsN derivations as described in clause 6.10.3.2 of 3GPP TS33.501. In this way, a security key (KsN) may be derived. It is to be understood that the determination of the security key based on the first counter value may be performed in any other suitable ways, and the present disclosure does not limit this aspect.

Upon determination of the security key, the MN 110 may transmit the security key to the SN 140 in a SN reconfiguration complete message or in a SN modification confirm message. Of course, the MN 110 may transmit the security key to the SN 140 in any other suitable messages.

Upon reception of the security key, the SN 140 may use 271 the security key for communication with the terminal device 120 in the subsequent CPC procedure.

In this way, a security key for SN may be derived after subsequent CPC is triggered, and the security key used for the subsequent CPC is different from that used for the previous cell change or addition.

### Embodiment 4

In this embodiment, the MN 110 preconfigures a set of security keys for SN and provides the set of security keys to a target SN or a source SN (for example, the SN 140). The SN 140 determines a security key from the set of security keys for the transmission with terminal device 120 of one subsequent CPC procedure based on information of the security key provided by the MN 110 or forwarded by the MN 110.

In some embodiments, the MN 110 may determine, from at least one set of counter values configured for the terminal device 120, a set of counter values that is used for the candidate cell. With reference to FIG. 2, the MN 110 may determine 254, as a set of first counter values, at least one counter value in the determined set of counter values. The at least one counter value is unused before the subsequent CPC. First counter values in the set of first counter values are different from each other.

In some embodiments, the MN 110 may determine the set of first counter values by increasing a counter value configured for the terminal device 120.

Based on the set of first counter values, the MN 110 may determine 255 the set of security keys. Security keys in the set of security keys are different from each other. For example, a first counter value in the set of first counter values may be used as freshness input into KsN derivations as described in clause 6.10.3.2 of 3GPP TS33.501, and thus a corresponding security key (KsN) may be derived. In this way, a set of KsN values may be derived. It is to be understood that the determination of a security key based on a first counter value may be performed in any other suitable ways, and the present disclosure does not limit this aspect.

Upon determination of the set of security keys, the MN 110 may transmit the set of security keys to SN. In some embodiments, the MN 110 may transmit the set of security keys to a target SN in a SN addition request message. In some embodiments, the MN 110 may transmit the set of security keys to a source SN in a SN modification request message. It is to be understood that the MN 110 may transmit the set of security keys in any other suitable ways.

In some embodiments, after triggering of the subsequent CPC, the terminal device 120 may transmit 272 a RRC reconfiguration complete message to the MN 110. Upon reception of the RRC reconfiguration complete message, the MN 110 may determine a security key in the set of security keys. In some embodiments, the RRC reconfiguration complete message may comprise information of a first counter value in the set of the first counter values. In some embodiments, the information of the first counter value may comprise at least one of the following: the first counter value, a difference between the first counter value and a counter value configured for the terminal device 120, or a count for the subsequent CPC. A count for the subsequent CPC can be the number of times of subsequent CPC procedures that have been performed. Of course, any other suitable information is also feasible.

Upon reception of the RRC reconfiguration complete message, the MN 110 may determine 273 a security key in the set of security keys based on the information of the first counter value. Then the MN 110 may transmit 274 information of the security key to the SN 140. For example, the MN 110 may transmit the information of the security key in a SN reconfiguration complete message or a SN modification confirm message or any other suitable messages. In some embodiments, the information of the security key may comprise at least one of the following: a count for the subsequent CPC, or an index of the security key. A count for the subsequent CPC can be the number of times of subsequent CPC procedures that have been performed. Of course, any other suitable information is also feasible. Upon reception of the information of the security key, the SN 140 may determine 275 the security key from the set of security keys.

In some embodiments, after triggering of the subsequent CPC, the terminal device 120 may transmit 276 a RRC reconfiguration complete message to the MN 110, which is called MN RRC reconfiguration complete message. The MN RRC reconfiguration complete message contains an RRC reconfiguration complete message to SN 140, which is called SN RRC reconfiguration complete message. The MN 110 may forward 277 the SN RRC reconfiguration complete message to the SN 140. Upon reception of the SN RRC reconfiguration complete message, the SN 140 may determine the security key from the set of security keys for the transmission between terminal device 120. In some embodiments, the SN RRC reconfiguration complete message may comprise information of the security key used by the terminal device 120. In some embodiments, the information of the security key may comprise at least one of the following: a count for the subsequent CPC, or an index of the security key. Of course, any other suitable information is also feasible. The SN 140 may determine 278 the security key from the set of security keys based on the information of the security key.

In this way, a set of security keys for SN may be preconfigured, and after subsequent CPC is triggered, a security key used for the subsequent CPC may be determined from the set of security keys, and the security key used for the subsequent CPC is different from that used for the previous cell change or addition.

### Example Implementation of No Change of Security Key for Subsequent CPC

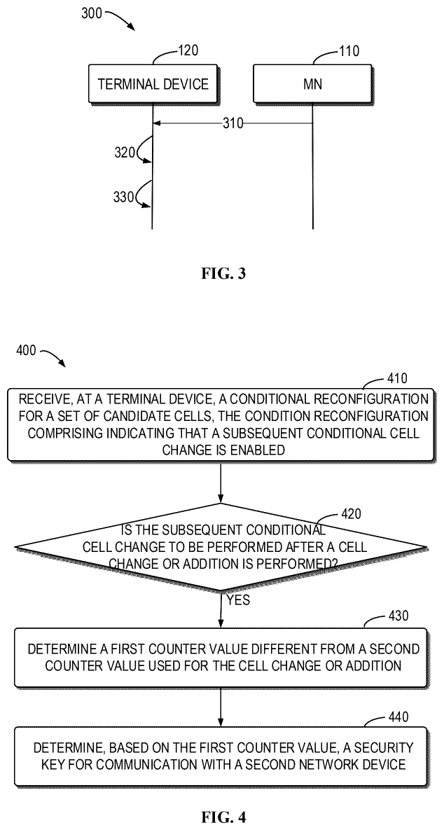

FIG. 3 illustrates a schematic diagram illustrating another example process 300 of determining a security key for a subsequent CPC according to embodiments of the present disclosure. For the purpose of discussion, the process 300 will be described with reference to FIG. 1A. The process 300 may involve the terminal device 120 and the network devices 110 and 140 as illustrated in FIG. 1A. In this example, the network device 110 is a MN serving the terminal device 120, the network device 140 is a potential target SN serving the terminal device 120. Assuming that the network device 130 is a source SN serving the terminal device 120 and the terminal device 120 is in the cell 131 (i.e., a source cell or current cell).

As shown in FIG. 3, the MN 110 transmits 310, to the terminal device 120, a conditional reconfiguration for a set of candidate cells. The set of candidate cells refers to one or more candidate cells. The conditional reconfiguration indicates that a subsequent CPC is enabled. In this embodiment, PDCP anchors of all the candidate cells are located in the same network entity. For example, all the candidate cells supporting a subsequent CPC belong to one centralized unit (CU) or integrated network device.

The terminal device 120 determines 320 whether a CPC (i.e., a subsequent CPC) is to be performed after a cell change or addition is performed. The subsequent CPC is to be performed from the current cell to a candidate cell (for example, the cell 142 provided by the SN 140) in the set of candidate cells.

If the subsequent CPC is to be performed, the terminal device 120 applies 330 the conditional reconfiguration for the SN 140 so that a security key used for the cell change or addition is the same as a security key used for the subsequent CPC.

In some embodiments, the terminal device 120 may maintain the security key used for the cell change or addition. In other words, the terminal device 120 does not derive the security key for SN. In some embodiments, the terminal device 120 may perform a PDCP recovery for at least one DRB. In some embodiments, the terminal device 120 may perform a PDCP service data unit (SDU) discard for at least one SRB. In other words, the terminal device 120 does not perform PDCP re-establishment. In this way, the terminal device 120 performs the above behavior regardless of the network configuration.

In some alternative embodiments, the conditional reconfiguration may indicate at least one of the following: no counter value being configured for determination of the security key; a PDCP recovery being performed for at least one DRB; or a PDCP SDU discard being performed for at least one SRB.

In this way, a terminal device does not need to change a security key for a subsequent CPC procedure.

### Example Implementation of Methods

Accordingly, embodiments of the present disclosure provide methods of communication implemented at a terminal device and a network device. These methods will be described below with reference to FIGS. 4 to 8.

FIG. 4 illustrates an example method 400 of communication implemented at a terminal device in accordance with some embodiments of the present disclosure. For example, the method 400 may be performed at the terminal device 120 as shown in FIG. 1A. For the purpose of discussion, in the following, the method 400 will be described with reference to FIG. 1A. It is to be understood that the method 400 may include additional blocks not shown and/or may omit some blocks as shown, and the scope of the present disclosure is not limited in this regard.

At block 410, the terminal device 120 receives, from a first network device (for example, the network device 110) as a MN, a conditional reconfiguration for a set of candidate cells, the conditional reconfiguration comprising information indicating that a subsequent conditional cell change is enabled.

At block 420, the terminal device 120 determines whether a subsequent conditional cell change to a candidate cell is to be performed after a cell change or addition is performed. If the subsequent conditional cell change is to be performed, the process 400 proceeds to block 430.

At block 430, the terminal device 120 determines a first counter value so that the first counter value is different from a second counter value used for the cell change or addition.

At block 440, the terminal device 120 determines, based on the first counter value, a security key for communication with a second network device (for example, the network device 140) as a SN providing the candidate cell.

In some embodiments, the conditional reconfiguration may comprise a counter value configured for the terminal device 120. In these embodiments, the terminal device 120 may store the counter value configured for the terminal device 120. In some embodiments, the terminal device 120 may store the counter value in a variable of the terminal device 120. In some embodiments, the terminal device 120 may store the counter value in an AS security context of the terminal device 120. In some embodiments, the terminal device 120 may store the counter value upon performing of the cell change or addition. In some embodiments, the terminal device 120 may store the counter value upon reception of the counter value in the conditional reconfiguration. In these embodiments, the terminal device 120 may determine the first counter value by increasing the stored counter value.

In some embodiments, the conditional reconfiguration may comprise at least one set of counter values configured for the terminal device 120. In some embodiments, the at least one set of counter values only comprises a set of counter values, the set of counter values being used for each candidate cell in the set of candidate cells. In some embodiments, the at least one set of counter values comprises a first set of counter values and a second set of counter values, the first set of counter values being used for a first candidate cell in the set of candidate cells, the second set of counter values being used for a second candidate cell in the set of candidate cells.

In these embodiments, the terminal device 120 may determine, from the at least one set of counter values, a set of counter values that is used for the candidate cell and determine, as the first counter value, a counter value in the set of counter values that is unused before the subsequent conditional cell change. In some embodiments, if no counter value in the set of counter values is unused before the subsequent conditional cell change, the terminal device 120 may discard a conditional reconfiguration entry and a measurement configuration for at least one candidate cell.

In some embodiments, if the subsequent conditional cell change is performed, the terminal device 120 may transmit information of the first counter value to the network device 110. In some embodiments, the terminal device 120 may transmit, to the network device 110, a RRC reconfiguration complete message comprising the information of the first counter value. In some embodiments, the information of the first counter value may comprise at least one of the following: the first counter value, a difference between the first counter value and a counter value configured for the terminal device, or a count for the subsequent conditional cell change.

In some embodiments, the terminal device 120 may transmit, to the network device 140 via the network device 110, a RRC reconfiguration complete message comprising information of the security key. In some embodiments, the information of the security key may comprise at least one of the following: a count for the subsequent conditional cell change, or an index of the security key.

With the method 400, a different counter value may be used for determination of a different security key for a subsequent conditional cell change compared with that for a previous cell change or addition.

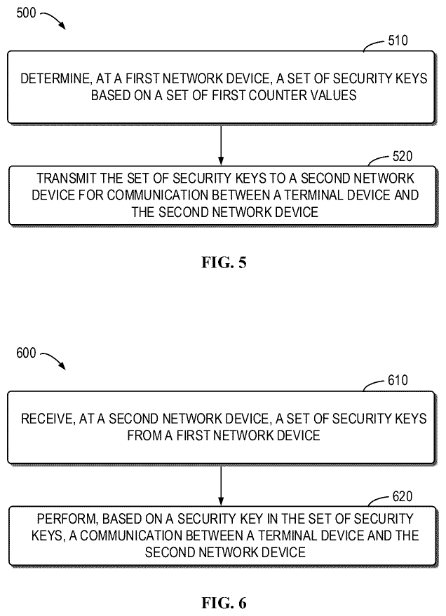

FIG. 5 illustrates an example method 500 of communication implemented at a first network device as a MN in accordance with some embodiments of the present disclosure. For example, the method 500 may be performed at the network device 110 as shown in FIG. 1A. For the purpose of discussion, in the following, the method 500 will be described with reference to FIG. 1A. It is to be understood that the method 500 may include additional blocks not shown and/or may omit some blocks as shown, and the scope of the present disclosure is not limited in this regard.

At block 510, the network device 110 determines a set of security keys based on a set of first counter values, the set of first counter values being used for a subsequent conditional cell change to be performed after a cell change or addition is performed and being different from a second counter value used for the cell change or addition. The subsequent conditional cell change is to be performed to a candidate cell in a set of candidate cells.

At block 520, the network device 110 transmits the set of security keys to a second network device (for example, the network device 140) providing the candidate cell for communication between the terminal device 120 and the network device 140.

In some embodiments, the network device 110 may transmit, to the terminal device 120, a conditional reconfiguration for a set of candidate cells, the conditional reconfiguration comprising at least one set of counter values. In some embodiments, the at least one set of counter values only comprises a set of counter values, the set of counter values being used for each candidate cell in the set of candidate cells. In some embodiments, the at least one set of counter values comprises a first set of counter values and a second set of counter values, the first set of counter values being used for a first candidate cell in the set of candidate cells, the second set of counter values being used for a second candidate cell in the set of candidate cells.

In some embodiments where the set of security keys comprises a security key and the set of first counter values comprises a first counter value, the network device 110 may determine the security key by receiving, from the terminal device, a RRC reconfiguration complete message; determining the first counter value; and determining the security key based on the first counter value.

In some embodiments, the network device 110 may determine the first counter value by increasing a counter value configured for the terminal device 120. In some embodiments, the network device 110 may determine the first counter value by determining, from at least one set of counter values configured for the terminal device 120, a set of counter values that is used for the candidate cell; and determining, as the first counter value, a counter value in the set of counter values configured for the terminal device 120, the counter value being unused before the subsequent conditional cell change.

In some embodiments, the network device 110 may determine the first counter value by receiving, from the terminal device 120, information of the first counter value; and determining the first counter value based on the information of the first counter value. In some embodiments, the network device 110 may receive the information of the first counter value from the RRC reconfiguration complete message. In some embodiments, the information of the first counter value may comprise at least one of the following: the first counter value, a difference between the first counter value and a counter value configured for the terminal device 120, or a count for the subsequent conditional cell change.

In some embodiments, the network device 110 may transmit the security key to the network device 140 in a SN reconfiguration complete message. In some embodiments, the network device 110 may transmit the security key to the network device 140 in a SN modification confirm message.

In some embodiments, the network device 110 may determine the set of security keys by determining from at least one set of counter values configured for the terminal device 120, a set of counter values that is used for the candidate cell; determining, as the set of first counter values, at least one counter value in the set of counter values that is unused before the subsequent conditional cell change; and determining the set of security keys based on the set of first counter values. In some embodiments, the at least one set of counter values only comprises a set of counter values, the set of counter values being used for each candidate cell in the set of candidate cells. In some embodiments, the at least one set of counter values comprises a first set of counter values and a second set of counter values, the first set of counter values being used for a first candidate cell in the set of candidate cells, the second set of counter values being used for a second candidate cell in the set of candidate cells.

In some embodiments, the network device 110 may determine the set of security keys by determining a set of first counter values by increasing a counter value configured for the terminal device 120; and determining the set of security keys based on the set of first counter values.

In some embodiments, the network device 110 may determine a security key in the set of security keys, and transmit information of the security key to the network device 140. In some embodiments, the network device 110 may receive, from the terminal device 120, information of a first counter value in the set of first counter values, and determine the security key in the set of security keys based on the information of the first counter value. Then the network device 110 may transmit information of the security key to the network device 140.

In some embodiments, the network device 110 may further receive, from the terminal device 120, a RRC reconfiguration complete message to be forwarded to the second network device, the RRC reconfiguration complete message comprising information of a security key in the set of security keys, and forward the RRC reconfiguration complete message to the network device 140.

In some embodiments, the information of the security key may comprise at least one of the following: a count for the subsequent conditional cell change, or an index of the security key.

With the method 500, a different counter value may be used for determination of a different security key for a subsequent conditional cell change compared with that for a previous cell change or addition.

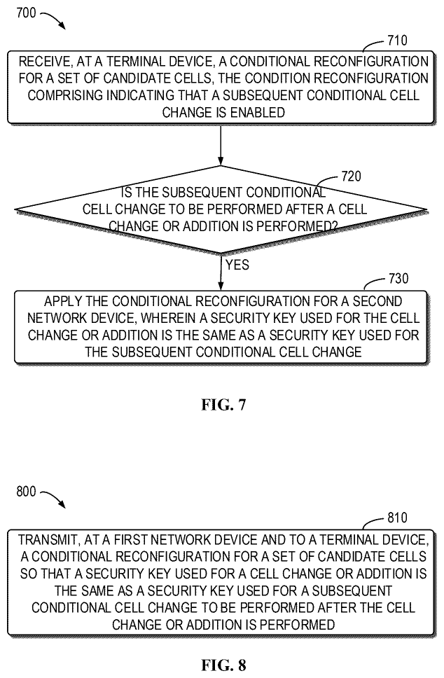

FIG. 6 illustrates an example method 600 of communication implemented at a second network device as a SN in accordance with some embodiments of the present disclosure. For example, the method 600 may be performed at the network device 130, 140 or 150 as shown in FIG. 1A. For the purpose of discussion, in the following, the method 600 will be described with reference to the network device 140 in FIG. 1A. It is to be understood that the method 600 may include additional blocks not shown and/or may omit some blocks as shown, and the scope of the present disclosure is not limited in this regard.

At block 610, the network device 140 receives a set of security keys from a first network device (for example, the network device 110). In some embodiments, the network device 140 may receive the security key from the network device 110 in a SN reconfiguration complete message or a SN modification confirm message. In some embodiments, the network device 140 may receive the set of security keys from the network device 110 by a SN addition request message or a SN modification request message.

At block 620, the network device 140 performs, based on a security key in the set of security keys, a communication between the terminal device 120 and the network device 140. The network device 140 provides a candidate cell to which a subsequent conditional cell change is to be performed after a cell change or addition is performed. The security key is used for the subsequent conditional cell change and is different from a previous security key used for the cell change or addition.

In some embodiments, the network device 140 may receive, from the network device 110, information of the security key, and determine the security key from the set of security keys based on the information of the security key. In some embodiments, the network device 140 may receive the information of the security key by receiving a RRC reconfiguration complete message forwarded by the network device 110, the RRC reconfiguration complete message comprising the information of the security key. In some embodiments, the network device 140 may receive the information of the security key by receiving, from the network device 110, a SN reconfiguration complete message comprising the information of the security key. In some embodiments, the network device 140 may receive the information of the security key by receiving, from the network device 110, a SN modification confirm message comprising the information of the security key.

In some embodiments, the information of the security key may comprise at least one of the following: a count for the subsequent conditional cell change, or an index of the security key.

With the method 600, a different security key is used for a subsequent conditional cell change compared with that for a previous cell change or addition.

FIG. 7 illustrates another example method 700 of communication implemented at a terminal device in accordance with some embodiments of the present disclosure. For example, the method 700 may be performed at the terminal device 120 as shown in FIG. 1A. For the purpose of discussion, in the following, the method 700 will be described with reference to FIG. 1A. It is to be understood that the method 700 may include additional blocks not shown and/or may omit some blocks as shown, and the scope of the present disclosure is not limited in this regard.

At block 710, the terminal device 120 receives, from a first network device (for example, the network device 110) as a MN, a conditional reconfiguration for a set of candidate cells, the conditional reconfiguration comprising information indicating that a subsequent conditional cell change is enabled.

At block 720, the terminal device 120 determines whether a subsequent conditional cell change to a candidate cell is to be performed after a cell change or addition is performed. If the subsequent conditional cell change is to be performed, the process 700 proceeds to block 730.

At block 730, the terminal device 120 applies the conditional reconfiguration for a second network device (for example, the network device 140) as a SN providing the candidate cell, wherein a security key used for the cell change or addition is the same as a security key used for the subsequent conditional cell change.

In some embodiments, the terminal device 120 may apply the conditional reconfiguration by at least one of the following: maintaining the security key used for the cell change or addition; performing a PDCP recovery for at least one DRB; or performing a PDCP SDU discard for at least one SRB.

In some embodiments, the conditional reconfiguration may indicate at least one of the following: no counter value being configured for determination of the security key; a PDCP recovery being performed for at least one DRB; or a PDCP SDU discard being performed for at least one SRB.

With the method 700, a security key does not need to be changed for a subsequent conditional cell change compared with that for a previous cell change or addition.

FIG. 8 illustrates another example method 800 of communication implemented at a first network device as a MN in accordance with some embodiments of the present disclosure. For example, the method 800 may be performed at the network device 110 as shown in FIG. 1A. For the purpose of discussion, in the following, the method 800 will be described with reference to FIG. 1A. It is to be understood that the method 800 may include additional blocks not shown and/or may omit some blocks as shown, and the scope of the present disclosure is not limited in this regard.

At block 810, the network device 110 transmits, to the terminal device 120, a conditional reconfiguration for a set of candidate cells so that a security key used for a cell change or addition is the same as a security key used for a subsequent conditional cell change to be performed after the cell change or addition is performed.

In some embodiments, the conditional reconfiguration may indicate at least one of the following: no counter value being configured for determination of the security key; a PDCP recovery being performed for at least one DRB; or a PDCP SDU discard being performed for at least one SRB.

With the method 800, a conditional reconfiguration is configured so that a security key does not need to be changed for a subsequent conditional cell change.

### Example Implementation of Device and Apparatus

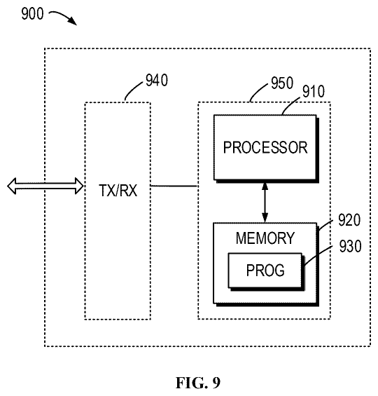

FIG. 9 is a simplified block diagram of a device 900 that is suitable for implementing embodiments of the present disclosure. The device 900 can be considered as a further example implementation of the terminal device 120 or the network device 110, 130, 140 or 150 as shown in FIG. 1A. Accordingly, the device 900 can be implemented at or as at least a part of the terminal device 120 or the network device 110, 130, 140 or 150.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 930 is assumed to include program instructions that, when executed by the associated processor 910, enable the device 900 to operate in accordance with the embodiments of the present disclosure, as discussed herein with reference to FIGS. 1A to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a terminal device comprises circuitry configured to: receive, from a first network device, a conditional reconfiguration for a set of candidate cells, the conditional reconfiguration indicating that a subsequent conditional cell change is enabled; in accordance with a determination that the subsequent conditional cell change to a candidate cell in the set of candidate cells is to be performed after a cell change or addition is performed, determine a first counter value, the first counter value being different from a second counter value used for the cell change or addition; and determine, based on the first counter value, a security key for communication with a second network device providing the candidate cell.

In some embodiments where the conditional reconfiguration comprises a counter value configured for the terminal device, the circuitry may be further configured to store the counter value configured for the terminal device. In some embodiments, the circuitry may be configured to store the counter value by at least one of the following: storing the counter value in a variable of the terminal device; storing the counter value in an AS security context of the terminal device; storing the counter value upon performing of the cell change or addition; or storing the counter value upon reception of the counter value in the conditional reconfiguration.

In some embodiments, the circuitry may be configured to determine the first counter value by determining the first counter value by increasing the stored counter value.

In some embodiments, the conditional reconfiguration comprises at least one set of counter values configured for the terminal device. In some embodiments, the at least one set of counter values only comprises a set of counter values, the set of counter values being used for each candidate cell in the set of candidate cells. In some embodiments, the at least one set of counter values comprises a first set of counter values and a second set of counter values, the first set of counter values being used for a first candidate cell in the set of candidate cells, the second set of counter values being used for a second candidate cell in the set of candidate cells.

In some embodiments, the circuitry may be configured to determine the first counter value by determining, from the at least one set of counter values, a set of counter values that is used for the candidate cell; and determining, as the first counter value, a counter value in the set of counter values that is unused before the subsequent conditional cell change.

In some embodiments, the circuitry may be further configured to: in accordance with a determination that no counter value in the set of counter values is unused before the subsequent conditional cell change, discard a conditional reconfiguration entry and a measurement configuration for at least one candidate cell.

In some embodiments, the circuitry may be further configured to: in accordance with a determination that the subsequent conditional cell change is performed, transmit information of the first counter value to the first network device. In some embodiments, the circuitry may be configured to transmit the information of the first counter value by transmitting, to the first network device, a RRC reconfiguration complete message comprising the information of the first counter value. In some embodiments, the information of the first counter value comprises at least one of the following: the first counter value, a difference between the first counter value and a counter value configured for the terminal device, or a count for the subsequent conditional cell change.

In some embodiments, the circuitry may be further configured to: transmit, to the second network device via the first network device, a RRC reconfiguration complete message comprising information of the security key. In some embodiments, the information of the security key comprises at least one of the following: a count for the subsequent conditional cell change, or an index of the security key.

In some embodiments, a first network device comprises circuitry configured to: determine a set of security keys based on a set of first counter values, the set of first counter values being used for a subsequent conditional cell change to a candidate cell in a set of candidate cells to be performed after a cell change or addition is performed and being different from a second counter value used for the cell change or addition; and transmit the set of security keys to a second network device providing the candidate cell for communication between a terminal device and the second network device.

In some embodiments, the circuitry may be further configured to: transmit, to the terminal device, a conditional reconfiguration for at least one set of candidate cells, the conditional reconfiguration comprising a set of counter values. In some embodiments, the at least one set of counter values only comprises a set of counter values, the set of counter values being used for each candidate cell in the set of candidate cells. In some embodiments, the at least one set of counter values comprises a first set of counter values and a second set of counter values, the first set of counter values being used for a first candidate cell in the set of candidate cells, the second set of counter values being used for a second candidate cell in the set of candidate cells.

In some embodiments where the set of security keys comprises a security key and the set of first counter values comprises a first counter value, the circuitry may be configured to determine the security key by: receiving, from the terminal device, a RRC reconfiguration complete message; determining the first counter value; and determining the security key based on the first counter value.

In some embodiments, the circuitry may be configured to determine the first counter value by: determining the first counter value by increasing a counter value configured for the terminal device.

In some embodiments, the circuitry may be configured to determine the first counter value by: determining, from at least one set of counter values configured for the terminal device, a set of counter values that is used for the candidate cell; and determining, as the first counter value, a counter value in the set of counter values that is unused before the subsequent conditional cell change.

In some embodiments, the circuitry may be configured to determine the first counter value by: receiving, from the terminal device, information of the first counter value; and determining the first counter value based on the information of the first counter value.

In some embodiments, the circuitry may be configured to receive the information of the first counter value by: receiving the information of the first counter value from the RRC reconfiguration complete message.

In some embodiments, the information of the first counter value comprises at least one of the following: the first counter value, a difference between the first counter value and a counter value configured for the terminal device, or a count for the subsequent conditional cell change.

In some embodiments, the circuitry may be configured to transmit the security key by at least one of the following: transmitting, to the second network device, the security key in a SN reconfiguration complete message; or transmitting, to the second network device, the security key in a SN modification confirm message.

In some embodiments, the circuitry may be configured to determine the set of security keys by: determining from at least one set of counter values configured for the terminal device, a set of counter values that is used for the candidate cell; determining, as the set of first counter values, at least one counter value in the set of counter values that is unused before the subsequent conditional cell change; and determining the set of security keys based on the set of first counter values. In some embodiments, the at least one set of counter values only comprises a set of counter values, the set of counter values being used for each candidate cell in the set of candidate cells. In some embodiments, the at least one set of counter values comprises a first set of counter values and a second set of counter values, the first set of counter values being used for a first candidate cell in the set of candidate cells, the second set of counter values being used for a second candidate cell in the set of candidate cells.

In some embodiments, the circuitry may be configured to determine the set of security keys by: determining a set of first counter values by increasing a counter value configured for the terminal device; and determining the set of security keys based on the set of first counter values.

In some embodiments, the circuitry may be further configured to: determine a security key in the set of security keys, and transmit information of the security key to the second network device. In some embodiments, the circuitry may be configured to determine the security key by: receiving, from the terminal device, information of a first counter value in the set of first counter values, and determining the security key in the set of security keys based on the information of the first counter value.

In some embodiments, the circuitry may be further configured to: receive, from the terminal device, a RRC reconfiguration complete message to be forwarded to the second network device, the RRC reconfiguration complete message comprising information of a security key in the set of security keys; and forward the RRC reconfiguration complete message to the second network device. In some embodiments, the information of the security key may comprise at least one of the following: a count for the subsequent conditional cell change, or an index of the security key.

In some embodiments, a second network device comprises a circuitry configured to: receive a set of security keys from a first network device; and performing, based on a security key in the set of security keys, a communication between a terminal device and the second network device providing a candidate cell, a subsequent conditional cell change to the candidate cell being to be performed after a cell change or addition is performed, the security key being different from a previous security key used for the cell change or addition.

In some embodiments, the circuitry may be configured to receive the set of security keys by: receiving the security key from the first network device in a SN reconfiguration complete message or a SN modification confirm message.

In some embodiments, the circuitry may be configured to receive the set of security keys by: receiving the set of security keys from the first network device by a SN addition request message or a SN modification request message.

In some embodiments, the circuitry may be further configured to: receive, from the first network device, information of the security key; and determine the security key from the set of security keys based on the information of the security key.

In some embodiments, the circuitry may be configured to receive the information of the security key by at least one of the following: receiving a RRC reconfiguration complete message forwarded by the first network device, the RRC reconfiguration complete message comprising the information of the security key; receiving, from the first network device, a SN reconfiguration complete message comprising the information of the security key; or receiving, from the first network device, a SN modification confirm message comprising the information of the security key.

In some embodiments, the information of the security key comprises at least one of the following: a count for the subsequent conditional cell change, or an index of the security key.

In some embodiments, a terminal device comprises a circuitry configured to: receive, from a first network device, a conditional reconfiguration for a set of candidate cells, the conditional reconfiguration indicating that a subsequent conditional cell change is enabled; and in accordance with a determination that the subsequent conditional cell change to a candidate cell in the set of candidate cells is to be performed after a cell change or addition is performed, apply the conditional reconfiguration for a second network device providing the candidate cell, wherein a security key used for the cell change or addition is the same as a security key used for the subsequent conditional cell change.

In some embodiments, the circuitry may be configured to apply the conditional reconfiguration by at least one of the following: maintaining the security key used for the cell change or addition; performing a PDCP recovery for at least one DRB; or performing a PDCP SDU discard for at least one SRB.

In some embodiments, the conditional reconfiguration may indicate at least one of the following: no counter value being configured for determination of the security key; a PDCP recovery being performed for at least one DRB; or a PDCP SDU discard being performed for at least one SRB.

In some embodiments, a first network device comprises a circuitry configured to: transmit, to a terminal device, a conditional reconfiguration for a set of candidate cells so that a security key used for a cell change or addition is the same as a security key used for a subsequent conditional cell change to be performed after the cell change or addition is performed.

In some embodiments, the conditional reconfiguration may indicate at least one of the following: no counter value being configured for determination of the security key; a PDCP recovery being performed for at least one DRB; or a PDCP SDU discard being performed for at least one SRB.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-46. (canceled)

47. A method of a User Equipment (UE), the method comprising;
receiving, from a Master Node (MN) in dual connectivity, a conditional reconfiguration which includes Secondary Node (SN) counter values; and
deriving a security key for subsequent mobility using a first unused SN counter value selected from the SN counter values.

48. The method according to claim 47, further comprising:
sending, to the MN, a Radio Resource Control (RRC) Reconfiguration Complete message which includes the first unused SN counter value.

49. The method according to claim 47, further comprising:
selecting the first unused SN counter value in the SN counter values; and
removing the first unused SN counter value from the SN counter values.

50. The method according to claim 47,
wherein the subsequent mobility includes a conditional PSCell change.

51. The method according to claim 47,
wherein each of the SN counter values is sk-Counter.

52. The method according to claim 47,
wherein the dual connectivity is Multi-Radio Dual Connectivity (MR-DC).

53. A method of a Radio Access Network (RAN) node which acts as a Master Node (MN) in dual connectivity, the method comprising:
sending, to a User Equipment (UE), a conditional reconfiguration which includes Secondary Node (SN) counter values,
wherein a security key for subsequent mobility is derived in the UE using a first unused SN counter value selected from the SN counter values.

54. The method according to claim 53, further comprising:
receiving, from the UE, a Radio Resource Control (RRC) Reconfiguration Complete message which includes the first unused SN counter value.

55. The method according to claim 53, further comprising:
deriving security keys corresponding to the SN counter values; and
sending, to an SN, an Xn message which includes the security keys.

56. The method according to claim 53,
wherein the subsequent mobility includes a conditional PSCell change.

57. The method according to claim 53,
wherein each of the SN counter values is sk-Counter.

58. The method according to claim 53,
wherein the dual connectivity is Multi-Radio Dual Connectivity (MR-DC).

59. A method of a Radio Access Network (RAN) node which acts as a Secondary Node (SN) in dual connectivity, the method comprising:
receiving, from a Master Node (MN), an Xn message which includes security keys corresponding to SN counter values,
wherein a security key for subsequent mobility is derived in the UE using a first unused SN counter value selected from the SN counter values.

60. The method according to claim 59, further comprising:
choosing the first unused SN counter value of the UE.

61. The method according to claim 59, further comprising:
selecting an appropriate security key based on the SN counter values.

62. The method according to claim 59,
wherein the subsequent mobility includes a conditional PSCell change.

63. The method according to claim 59,
wherein each of the SN counter values is sk-Counter.

64. The method according to claim 59,
wherein the dual connectivity is Multi-Radio Dual Connectivity (MR-DC).

65. A User Equipment (UE) comprising;
a memory; and
a processor coupled with the memory, wherein the processor is configured to:
receive, from a Master Node (MN) in dual connectivity, a conditional reconfiguration which includes Secondary Node (SN) counter values, and
derive a security key for subsequent mobility using a first unused SN counter value selected from the SN counter values.

66. A Radio Access Network (RAN) node which acts as a Master Node (MN) in dual connectivity, the RAN node comprising:
a memory; and
a processor coupled with the memory, wherein the processor is configured to:
send, to a User Equipment (UE), a conditional reconfiguration which includes Secondary Node (SN) counter values,
wherein a security key for subsequent mobility is derived in the UE using a first unused SN counter value selected from the SN counter values.

67. A Radio Access Network (RAN) node which acts as a Secondary Node (SN) in dual connectivity, the RAN node comprising:
a memory; and
a processor coupled with the memory, wherein the processor is configured to:
receive, from a Master Node (MN), an Xn message which includes security keys corresponding to SN counter values,
wherein a security key for subsequent mobility is derived in the UE using a first unused SN counter value selected from the SN counter values.
